(19) United States
(12) Patent Application Publication
(10) Pub. No.: US 2013/0286825 A1
(43) Pub. Date: Oct. 31, 2013

(54) FEED-FORWARD ARBITRATION

(71) Applicants: Derek Alan Sherlock, Boulder, CO (US); Gary Gostin, Plano, TX (US)

(72) Inventors: Derek Alan Sherlock, Boulder, CO (US); Gary Gostin, Plano, TX (US)

(21) Appl. No.: 13/459,917

(22) Filed: Apr. 30, 2012

(51) Int. Cl. H04L 12/26

(52) U.S. Cl. 370/230

(57) ABSTRACT

Feed-forward arbitration is disclosed. An example method of feed-forward arbitration includes determining an aggregated measure of urgency of packets waiting in a queue. The method also includes sending the aggregated measure to switching node arbiters along the path that an urgent packet will take, to reduce backpressure along a path of an urgent packet by biasing arbiters in favor of the packet

### BACKGROUND

In the field of large scalable fabric-based computer systems, packets traverse between protocol agents via multiple paths, with each packet passing through consecutive point-to-point fabric links, which in turn connect to consecutive switching nodes. The nodes handle the packets in the fabric. At each node, packets may converge from many source links onto one destination link, may diverge from one source link to many destination links, or any permutation thereof. A typical architecture may implement the switching nodes as fully-connected crossbars, or a more restrictive switching subset.

A particular node may participate in many end-to-end paths. Some of these paths may be long, while others are short. But even if two paths are of equal length, a particular switching node may occupy a different position within the two paths. For example, the node may be early in the path of one packet, and the same node may be later in the path of another packet. Thus, it is difficult for a node to prioritize packets from competing source links and destination links.

### BRIEF DESCRIPTION OF THE DRAWINGS

FIG. 1 is a high-level diagram of an example switched fabric which may implement feed-forward arbitration.

FIG. 2 shows a two-input, two-output example node.

FIG. 3 shows multiple nodes such as the node shown in FIG. 2, wherein an output of one of the nodes drives an input of the other node via a link.

FIG. 4 is a flowchart illustrating example operations which may be implemented for feed-forward arbitration.

### DETAILED DESCRIPTION

So-called “long-haul” packets (those packets traveling through more links in the fabric) are at a disadvantage compared to so-called “short-haul” packets (those packets traveling fewer links in the fabric). Of course, there is a whole continuum of route lengths. Because the long-haul packets pass through more switching nodes, these packets have to arbitrate more times en-route to the destination node. If there is a bottleneck anywhere between the source node and the destination node (e.g., at the destination protocol agent where packets arriving from many competing paths converge), “flow-control back-pressure” in fabric traffic extends upstream along the converging paths. The volume of this back-pressured fabric traffic can extend back through multiple links, propagating this backpressure upstream.

Long-haul packets pass through more links, and thus are exposed to a disproportionately smaller portion of the available bandwidth at the ultimate bottleneck location, as compared to otherwise equivalent short-haul paths. Thus, long-haul packets spend more time in queues waiting in en-route switch queues for the backpressure to clear. For purposes of illustration, if each link has ten competing inputs, and each link implements an independent round-robin arbitration, a “four-hop” path may make end-to-end forward progress one out of one-hundred times as often as a “two-hop” path. Accordingly, long-haul packets experience excessive queuing delays because these packets are disproportionately disadvantaged by backpressure from downstream bottlenecks.

In some system topologies, the links that converge at a switching node may represent unequal numbers of converging routes or endpoints. In a well-designed fabric, they should nonetheless represent about equal traffic volumes, so that both links are well-utilized, yet neither link is overloaded. For example, it is possible that one input link carries a low volume of traffic from each of many source endpoints, while another input link carries a high volume of traffic from only one endpoint. Their traffic converges to a single output of a switching node. A common example where such traffic convergence occurs, yet the two links carry approximately equal traffic volumes, occurs where long-haul traffic arrives from a distant portion of a system, and merges with short-haul traffic from a nearby part. Because proper NUMA design dictates that each endpoint's volume of short-haul traffic volume is much higher than its long-haul traffic, a single link may carry traffic from many distant endpoints, whereas a single link carries competing traffic from only one nearby endpoint. Thus the two links carry equal traffic volumes yet represent entirely different numbers of source endpoints, and entirely different numbers of converged routes.

So long as the system is operating nominally, the balance of long and short-haul traffic is as expected, and queues are not running full, this works well. Long haul traffic has less link bandwidth available than short, but the amounts are correctly proportioned relative to the system design's needs. And, because the two queues both carry approximately equal volumes of packets, very simple arbitration (e.g., round-robin) may be adequate. However, the equilibrium can be upset by any factor that disturbs the balance of long versus short-haul traffic. Because the long-haul routes already include much convergence upstream of the point where they merge with short-haul routes, they do not tolerate backpressure as readily as the short-haul ones.

During arbitration, the inherent unfairness between so-called long-haul and short-haul traffic can raise several issues. In a well-tuned large scalable system, the need for long-haul traffic should generally be rare. With good NUMA-optimized design and sensible allocation of resources to partitions, among other considerations, the bulk of traffic is typically short-haul. Such NUMA-optimization improves performance by allowing the majority of traffic to take advantage of lower latencies, in addition to reducing the likelihood of a system cross-section-bandwidth bottleneck.

However, even if long-haul traffic is lower in volume, handling these packets is still a consideration for overall system performance. Long haul traffic often handles latency-sensitive synchronization events, such as semaphores. These packets may also exist where NUMA optimization is sub-optimum due to the sheer scale of a non-partitioned workload, the physical location of immobile resources, or the prior failure of redundant system components, among other examples.

In addition, while long-haul traffic is typically low in volume, there may exist poorly-optimized configurations, or even brief periods of time in well-optimized configurations, where a high-volume of traffic crosses long paths in competition with normal high-volume, short-haul traffic that shares the same, links, and/or switches. In these examples, long-haul packets may be subject to queuing delays, in some instances many orders of magnitude greater than the average delivery time for all packets in the system. Long packet delivery delays pose operating system and application reliability issues, and can also make it difficult or impossible to design other time-threshold triggered mechanisms within the switched fabric 100, such as timeout-based redundant failover and timeout-based error detection to name only a few examples.

When examined from a whole-system perspective, arbitration algorithms such as independent round-robin do a poor job of handling competition between short-haul and long-haul traffic. Such an approach tends to favor packets on short paths, at the expense of packets on longer paths. Other approaches attempt to address this problem by statically biasing arbiters to favor switching node inputs known to carry long-haul packets over those carrying short-haul packets. This bias can be restrictive on supported system topologies because physical segregation is then needed between long-haul and short-haul packets, which is frequently not compatible with other system design constraints. Static biasing where long and short haul routes merge can also result in an inversion of the original problem, that is, an unusual volume of long-haul traffic can take precedence and essentially “starve out” the short-haul traffic.

Feed-forward arbitration is disclosed which may be implemented by switching nodes to assist in arbitration decisions for various competing paths. Feed-forward arbitration is a dynamic priority schema where each arbiter assesses queue priority based upon aggregate measures of waiting-packet urgency that have been fed forward from upstream queues. The arbiters select a next “winning queue” for a shared link. In an example, a feed-forward arbitration system includes a controller associated with each queue, which determines the relative aggregated measure of urgency of packets from the queue waiting to be sent through a downstream link. It is noted that the urgency is relative. That is, the arbiters described herein are biased according to the relative urgency of all competing queues. Thus, urgency may be expressed on a scale with a range of values. The system also includes an arbiter at an output link.

The feed-forward information is an aggregated measure. That is, the feed-forward information is based on information from a plurality of packets in the queue. The feed-forward information may also be based on information from multiple queues. The aggregated measure may be used in a feed-forward manner (e.g., sent along a path of a packet in the switched fabric to one or more nodes) to provide more uniform latency performance. Feed-forward meta-information rides on the links separately from the payload packets.

Feed forward information travels independently of the payload packets. Feed forward information may be aggregated over not only the entries in the single queue, but also the aggregated value received at the input link representing further-upstream queues waiting to send packets to the queue in question.

By aggregating the urgency for all packets in the queue, combined with the aggregated urgency received from the input link representing packets in upstream queues waiting to cross the input link that feeds the queue, all of the urgency information is distilled into a single number for each competing queue at an arbitration point. Note that information about the aggregated urgency of all waiting packets is referred to as “meta-information,” in that this information is not payload packet data, and thus is not subject to flow control in its own right, and can flow forward even when the payload data is back-pressured.

This Feed-forward arbitration is implemented in lossless networks, where flow-controlled back-pressure regulates forward progress and packets are not discarded. If the packets cannot be accepted by the next switching node (e.g., because there is no free space to store the packets), then the packet may not be sent by the previous node. Inability to send a packet across a link until the destination node can accept the packet is referred to herein as “backpressure.” Backpressure does not exist in lossy protocols such as are used on all LANs and most WANs. In a back-pressuring fabric, if a switching node cannot accept a packet, that packet must wait at the head of the queue until space becomes available in the next switching node along its route. Thus the queuing delays of that packet and all those in line behind it are affected by backpressure.

The aggregate measure may be determined based on urgency of a packet in a queue. Example criterion for determining urgency includes, but is not limited to, packet age, route length, and remaining hops along the path. Example methods for aggregating these values across many packets include, but are not limited to, using the sum, average, or maximum value.

It is noted that although there may be time or age stamps in packet headers, as part of tracking a packet's age as an urgency criterion, these stamps on the packet header convey the age of only the packet to which the header is attached. The “fed-forward” information concerns the aggregated age of all packets in storage waiting to be sent on a link. Accordingly, the aggregate measure for the link is distinct from the time-stamp information on individual packets being sent.

The aggregate measure may be sent across a link between packets, or during times when the link would otherwise be idle. Because the aggregated measure represents the urgency of all packets waiting to be sent, the aggregate measure is not associated with any one single packet, but with the link as a whole.

Accordingly, the feed-forward arbitration approach increases fairness between multiple competing packets on different paths sharing at least some resource along the path, by reducing the frequency and duration of backpressure caused by less urgent traffic, along the entire path to be taken by a more urgent packet.

Feed-forward arbitration may be implemented in any network where a particular packet's route is invariant, and segment-by-segment arbitration priorities can vary. These conditions typically hold in an inter-component fabric within a computer system. These types of network cannot always route around congestion by sending packets adaptively along different routes, e.g., because of ordered delivery requirements using deterministic routes to avoid accidental re-ordering, or because all routes are equally congested, or because the design operates at timescales where feedback about congestion doesn't reach the places where routing decisions are made in time to affect routing choices effectively. A design which attempts to route around downstream congestion is based upon feedback, which is a different concept from the feed-forward described herein.

Feed-forward arbitration addresses issues related to head of line blocking. Head-of-line blocking occurs, for example, when the packet at the head of a FIFO queue (e.g., waiting to go out over a link from a crossbar chip) is unable to make expeditious forward progress because it is competing with many other queues for the same outbound link. There is typically nothing about that packet to distinguish it as being more urgent than any of the competing packets. Indeed the head packet in the queue may not be any more urgent, except that further back in the same queue, another packet is waiting that is more urgent. So, the head packet blocks the entire queue from making expeditious forward progress. Only when all the packets ahead of the urgent one have been sent over the link, does the urgent packet reach the front of the queue. And if the ones ahead of it are competing with many other queues via an unbiased arbitration (e.g. round-robin), that might be a long time.

Before continuing, it is noted that as used herein, the terms “includes” and “including” mean, but is not limited to, “includes” or “including” and “includes at least” or “including at least.” The term “based on” means “based on” and “based at least in part on.”

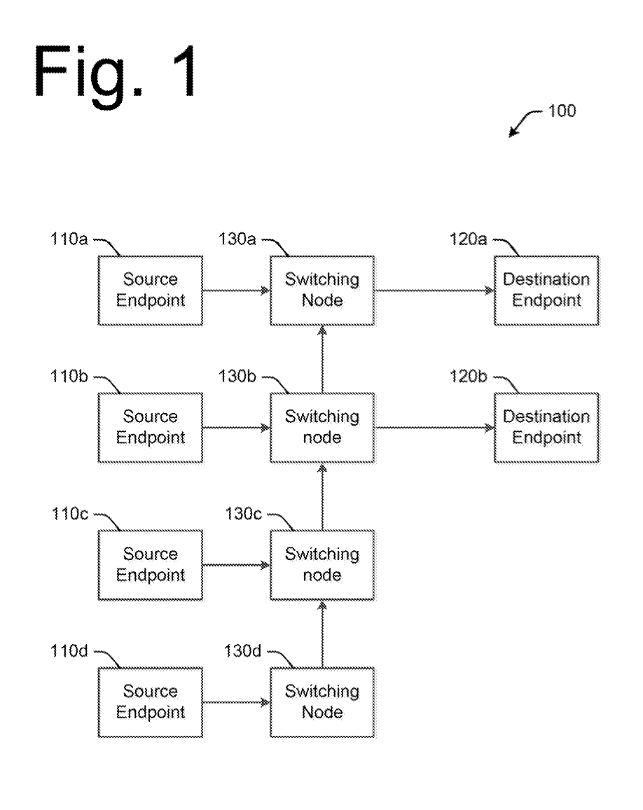

FIG. 1 is a high-level diagram of an example switched fabric 100 which may implement feed-forward arbitration. Switched fabric 100 may be implemented in any of a wide variety of computing environments. Example fabrics 100 include, but are not limited to, switched fabrics such as QPI, Hypertransport, and PCIe. These fabrics are usually implemented with routers which preserve packet order, except where mandatory passing is required by protocol ordering rules. In order queues (FIFOs) are usually used because they are relatively simple to implement, and in some cases because of protocol ordering requirements, or because the application of more complex queuing structures is not viable within the very short times needed to achieve acceptable fabric performance in these devices.

In an example, the switched fabric 100 may include nodes, such as source nodes 110a-d generating packet(s) to be transmitted via switching nodes 130a-d to destination node(s) 120a-b. The switching nodes may be implemented as crossbar chips within the switched fabric 100 (e.g., connecting processor chips together in a computer system). The nodes may include queues (e.g., implemented in a latch array on a VLSI device) for storing packets waiting to be sent on outbound links.

To illustrate that traffic converging in a switching node may include a mix of long-haul and short-haul traffic, consider a mix of traffic arriving at destination endpoint 120a from all source endpoints 110a-d. Traffic from source endpoint 110a arrives at 120a after two link traversals (or “hops”), via switching node 130a. Traffic from source endpoint 110d arrives at 120a after five hops, via switching nodes 130d, 130c, 130b and 130a.

In the above example, traffic from 110a to 120a occupies one queue within switching node 130a, while traffic from 110b-e all share a second queue. This is an example of how a single queue may carry traffic from one endpoint while competing with a second queue that carries traffic from several, more distant endpoints. The arbiter governing traffic sent out of 130a towards 120a must arbitrate between these two queues.

Consider traffic from source endpoint 110c to destination endpoint 120a, simultaneous with traffic from source endpoint 110d to destination endpoint 120b. This pattern illustrates how traffic in two queues competing to cross a link may include packets at different points within equal-distance routes. In switching node 130c, traffic from 110c competes with traffic from 110d (by way of 130d) to be sent from 130c to 130b. Both routes are the same length (four hops), but the arbiter in 130c is arbitrating between traffic from 110c that has already completed only one hop, and traffic from 110d that has already completed two hops.

Consider traffic from source endpoint 110c to both destination endpoints 120a-b. This pattern illustrates divergence in 130b, where packets arriving from 130c enter different output queues upon arrival at 130b, depending upon their eventual destination. This traffic flow illustrates a case where backpressure on the 130c to 130b link due to a full queues in 130b targeting 120b can victimize traffic bound for 120a through head-of-line blocking, even though no queue in the victim traffic's route is full.

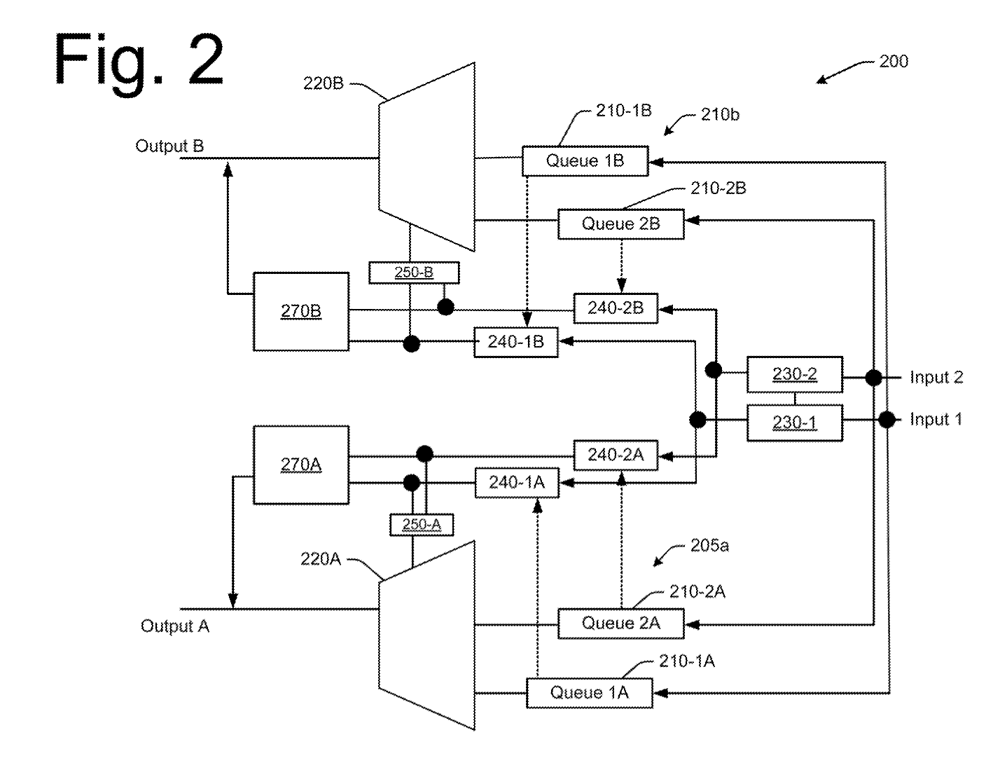

When routes converge within a switching node, there is potential for bottlenecks, because many links converging upon a single link can potentially overwhelm that link's capacity. Convergence should not create bottlenecks in a well-designed fabric under normal operating conditions, because there will also be compensating divergence. Each of the switching node input links participating in the convergence pattern would also carry packets that diverge to many switching node output links, so that the combined fraction of arriving packets from all inputs of the switching node targeting any given output is small enough to avoid overloading that output link. In the example shown in FIG. 2 (discussed in more detail below), traffic arriving at each of Inputs 1 and 2 might divide itself about equally between Outputs A and B. Because only about half of Input 1's traffic goes to Output A, as does about half of input 2's traffic, the total traffic on Output A is about the same as on one of the inputs. The two-to-one convergence at the outputs is offset by one-to-two divergence at the inputs.

However, under less ideal conditions, the aggravating factors already mentioned such as poor NUMA optimization, large non-partitioned workloads, and redundant component failures can cause convergence to exceed divergence in a manner that overloads one switching node output link. When these occur, backpressure propagates upstream, as queues fill up in each upstream switching node. Each time an output queue makes progress, the input link feeding the queue that made progress momentarily ceases to be back-pressured. The arbiter in the next switching node upstream must in turn select one if its inputs to make progress. If the upstream node has n inputs, each of its inputs will make forward progress every n′th time this occurs. In this scenario, a node's n-way convergence can be thought of equivalently as either dividing output link downstream bandwidth by n as seen by each of the converging input links, or as multiplying the output link's backpressure duration by n, as seen by each input link.

Consider the case where a switching node output's queues remain non-full, and thus its input links never backpressure. This can be sustained indefinitely only if the combined arrival rate of packets from all input links for a given output is less than or equal to the capacity of that output to send out packets. So long as this condition persists, sometimes called “arrival rate limited” switching, arbiter behavior is already optimum in the sense that each input separately and all inputs collectively are keeping up with arrivals. Any accumulating backlog would eventually fill one or more queues.

In this steady-state condition, then, no change in arbiter behavior could speed up the draining of queues from upstream switching nodes, because all such links are already operating unhindered by backpressure. Changes in arbiter behavior could still affect relative end-to-end packet delivery latencies, by rebalancing relative queue operating depths within the switching node, but could not improve upon input link utilization and bandwidth.

Thus, so long as a switching node's queue from a given input is continually non-full, there may be no need for that input's urgency aggregators to consider the fed-forward urgency of upstream queues when aggregating urgency for that input for use by the arbiter and the downstream nodes. This is a design choice that can be made based upon whether or not the impact of queue operating depth is a concern for the design.

It may be unnecessary to feed-forward urgency information across a link that is not back-pressured. Thus, Queuing-delay occurs when the links between successive switches are back-pressured, and long-haul versus short-haul fairness is desired to offset the disadvantages otherwise experienced by long-haul traffic. Thus, it may be adequate to communicate feed-forward information only on idle-link packets. If the links are not idle, there is no backpressure, and the arbiters can revert to a default weighting. Such an implementation enables operation without incurring feed-forward link bandwidth overhead. This optimization does not generalize to the case with independent flow-control domains, discussed below. If one flow-control domain is back-pressured while another is not, fed-forward meta-information on behalf of the backpressured flow-control domain still competes for link utilization with payload packets for the non-back-pressured link.

Instead of making each arbiter at each switch independent of the others, arbitration can be centralized. A centralized arbiter can potentially have enough information to predict where and when queuing occurs, and make decisions that balance short and long-haul packet delivery needs. But centralized arbitration can be difficult to implement in a large fabric, and may create an undesirable single point of failure in an otherwise high availability fabric.

A feed-forward technique is disclosed herein, which may be implemented as a stand-alone technique and/or in combination with one or more of existing approaches. The feed-forward technique provides meta-information about the urgency of packets in any switch queue in the switched fabric 100. For example, if packets will be made to wait in a queue for an opportunity to cross a heavily contested link, meta-information can be sent across the link that reflects the relative urgency of the waiting packets. This meta-information may be used to influence the next switch's arbitration priority, to give the arbiters governing progress of a queue along the proposed path a higher relative priority than of competing queues containing only less urgent packets. The meta-information received by the next switch may in turn be further fed forward to other switches along the proposed path in aggregated form, enabling switching nodes all along an end-to-end path to make accelerated forward progress for individual or groups of packets based upon their urgency, and for the packets ahead of the urgent packet(s) on the respective routes.

The meta-information used to make this determination may reflect any suitable characteristic of the packet. Examples of such characteristics include but are not limited to age (e.g., elapsed time from issuance by a source protocol agent), path length (e.g., total number of hops in the entire path), and elapsed path length (e.g., number of hops already taken). Other criterion may also be used separately or in combination. Quality of Service (QoS) may also be used. For example, a packet with a need for high QoS may be considered urgent when it enters the fabric, even if other criteria such as packet age do not otherwise identify the packet as being urgent. As with any other urgency criteria, there may be a whole continuum of different QoS levels. Similarly, aggregation functions may be for example, sum of ages of all waiting packets, age of oldest waiting packet, highest waiting QoS level, and greatest route length of all waiting packets.

For the purposes of illustration, the meta-information may be packet age (elapsed time because it was created by the source protocol agent). Packet age is an interesting and challenging example, because age changes with time, is difficult to aggregate across multiple packets, and poses implementation issues in the absence of a synchronized system-wide time reference.

Packet age directly measures the most troublesome aspect of fabric arbitration, that is, the total queuing delay. If individual arbiters use dynamically adjusted weightings to substantially equalize packet ages arriving at each destination protocol agent, then the fabric closely resembles a truly uniform fabric, even if the underlying physical implementation is far from uniform. Packet age, once measured and bounded, levels the resulting “playing field” between packets regardless of path distance, and thus forms the basis for a sound timeout-based failover and error hierarchy.

To implement the feed-forward approach based upon packet age, each packet may carry age information in a header whenever the packet is stored in a switch queue. To keep this information meaningful over time without requiring a separate timer for each stored packet, the information can be stored in the form of a creation-time stamp. Thus, at any given time, the age of a packet can be calculated by comparing the packet timestamp to the node's free-running time reference or counter. To keep the timestamps and counters to a finite width, modulo-arithmetic may be used, with the timestamp/counter widths and time granularity (or “tick”) chosen appropriately. However, modulo-arithmetic fails if a packet becomes older than the maximum representable age. Therefore; the time stamp/counter width and granularity (tick duration) should be selected such that the oldest possible packet that can be present anywhere in the fabric is represented without overflow.

Feed-forward arbitration “tells” the arbiter how urgent each queue is, so that the arbiter can favor the more urgent packets over the less urgent packets. Feed-forward arbitration can also be used for classifying a queue's urgency, based not just on the urgency of the packet at the head, but on the combined or aggregated urgency of all packets waiting in that queue, or even waiting in other queues in other upstream switching nodes bound for that queue.

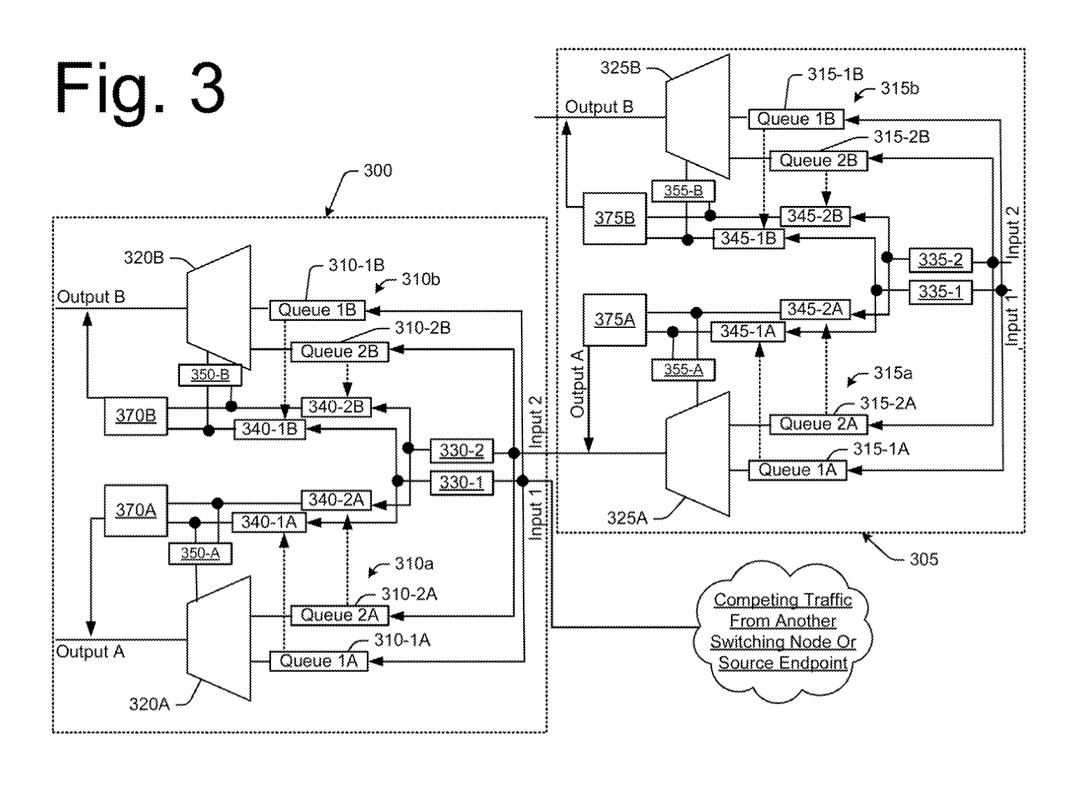

FIG. 2 shows a two-input, two-output example node 200. In FIG. 2, reference numbers with -1 and -2 refer to Input 1 and Input 2, respectively. FIG. 3 shows multiple nodes such as the node shown in FIG. 2, wherein an output of one of the nodes drives an input of the other node via a link. That is, the system fabric includes two nodes 300 and 305, where output A of node 305 drives a link which in turn drives input 2 of node 300. In each of these figures, reference numbers with designator A correspond to output A, and reference numbers with designator B correspond to output B in the nodes 200, 300, or 305. The description of like components may not be repeated for each input and/or output.

Because the applicable types of fabric (e.g., QPI links, WJF links, PCIe links) utilize arbitration cycles at often sub-nanosecond repetition rates, the elements may be constructed natively in hardware, for example, using logic gates, state machines, etc.

The node 200 is shown as a fully connected 2-input 2-output crossbar. In this illustration, FIFO queues 210 are shown from each input to each output via multiplexer 220. Although FIG. 2 depicts a node with only two inputs and two outputs, for illustrative purposes, in practice any number of inputs and outputs could exist. It is noted that a fully-connected n-input n-output crossbar has FIFO queues n-squared in number. Each output thus includes an n-way multiplexer picking from the n queues of packets that were received destined for that output from the n separate inputs.

Although depicted in the drawings and described herein as output-queued switches, it is noted that the techniques described herein may be used with any type of switching node queue structure

An arbiter 250 chooses which of the n queues that feed an output get to make forward progress next. Arbitration choices can be biased based on fed-forward urgency criteria.

Logic block 230 receives urgency information from an upstream link (Input 1 and Input 2). Aggregator 240 aggregates this information with the urgency information of packets already stored in the queue 240. Arbiter 250 selects the next winning queue based upon the relative queue priorities received from the aggregators 240, and controls the output multiplexor 220 accordingly.

It is noted that each queue has an aggregator 240 that aggregates the urgency of the packets stored within. Logic blocks 240 aggregates together the urgency information (e.g., calculates the oldest age) for all entries in the queue with which the urgency information is associated, and feeds this information to the arbiter 250 which biases arbitration decisions based upon the relative urgency of the packets in each of the competing queues 240. It also feeds this information to logic block 270, where it is aggregated across all queues converging on an output, and thence sent across the link as a measure of the aggregated urgency of all packets in all queues waiting to cross the link.

Each input has a logic block 230 that receives urgency information from upstream switches across the link. Note that this same received urgency information is replicated to the logic blocks 240 of all queues to which that link traffic can diverge, because the urgency is associated with packets in upstream switching node queues which may ultimately target any or all of these queues. Each block 240 aggregates urgency of packets stored in the queue, along with received urgency from upstream queues (via logic block 230), and feeds the aggregated urgency to the relevant arbiter 250 and the relevant output's logic block 270. The output has a logic block 270 which aggregates together the urgency of all queues that converge on that output, and sends it on down the link as feed-forward urgency representing the urgency of all traffic waiting to cross the link.

With reference to FIG. 3, during operation, urgency information in a queue (e.g., 315-2A) in the upstream node 305 is aggregated by aggregator 345-2A, fed to that node's arbiter 355A and also aggregated at logic block 375A with urgency in other queues waiting for the link (e.g., 315-1A by way of aggregator 345-1A). The combined urgency of all queues (e.g., the age of the oldest packet in all queues) is fed-forward down the link (305's Output A to 300's Input 2), where the downstream switching node 300 receives the feed-forward information via logic block 330-2, aggregates the feed-forward information with urgency of packets in the queues (310-2A and 310-2B) via aggregators (340-2A and 340-2B), thereby informing the arbiters (350-A and 350-B) of the relative urgency of the queues competing to make forward progress via the multiplexors (320A and 320B) to the two outputs. Thus, urgency of packets in the upstream switching node's queues (315-1A and 315-1B) influences the arbitration of the downstream switching node's arbiters (350-A and 350-B). An urgent packet in, say, queue 315-2A in upstream node 305, elevates the priority that arbiter 350-A applies to queue 310-2A, and similarly elevates the priority that arbiter 350-B applies to queue 310-2B, both in downstream node 300.

Because arbitration is based upon relative urgency information, the elevation in priority that arbiter 350-A applies to traffic from queue 310-2A occurs at the expense of relatively lower urgency competing traffic from queue 310-1A.

For purposes of illustration, consider the example shown in FIG. 2 where packets from queue 210-1A reach a two-way arbiter 250-A. Traffic in the queue 210-1A includes an urgent packet behind 12 less urgent packets. Competing queue 210-2A also contains packets of relatively low urgency. Packet urgency may be determined by attributes of the packets in queues 210, such as age, or in combination with fed-forward information from upstream nodes.

The urgent packet in queue 210-1A must reach the head of its queue before it can make progress to Output A. In the absence of any special handling, using round robin arbitration between the competing queues 210-1A and 210-2A, the 12 packets ahead of the urgent packet will exit output A after 24 arbitration cycles, during which time, the urgent packet must wait. The number of arbitration cycles increases with the number of competing queues, so for example in a 10-input switching node, the delay would be 120 arbitration cycles.

If instead, the queue 210A is known to be urgent using “feed forward” information, the arbiter 250-A decision can be biased. Instead of taking equal turns between competing queues 210-1A and 210-2A, the arbiter can bias in favor of queue 210-1A, by selecting it for forward progress, more often than competing queue 210-2A. In the most extreme case, where 210-1A urgency is so high that it is allowed to win the arbitration every single time, the number of arbitration cycles to clear the backlog and get the urgent packet to the front of queue 210-1A drops from 24 to 12. This reduction in queuing delay for an urgent packet is a direct consequence of feeding forward urgency information and biasing arbitration, accordingly.

Because the example shows only two competing queues, only a modest 2× improvement was achieved, with the urgent packet experiencing a queuing delay reduction from 24 to 12 packet-send times. In other implementations where the fan-in (number of competing queues at the arbiter) is greater, the corresponding saving in queuing delay is correspondingly larger. For example, if there are 10 queues, the queuing delay would have dropped by a 10 times factor, from 120 to 12 arbitration cycles.

In the illustration shown in FIG. 3, packets arriving from inputs 1 and 2 of switching node 300 converge at output A. Being an output-queued switch, convergence occurs at the output links, controlled by the arbiters whose bias is the subject of this invention. Divergence, on the other hand, occurs at the input, in that arriving packets are put into the correct output's queue upon arrival.

Backpressure on the input link may arise even if only one of these queues is full, if the link does not support independent flow-control based upon next-hop destination. The entire input link is back-pressured. This choice of link flow-control capability is consistent with the prior switching node driving the link also being an output-queued switch. Even if it were possible to signal flow control independently per next-hop link, the previous switching node may still be head-of-line blocked by a packet destined for the full queue, and per-next-hop flow control capability would add little value.

Backpressure from just one output link's queue being full (e.g. queue 310-2A) can prevent packets bound for divergent queues from making forward progress even if their queues are not full. For example, consider when queue 310-2A is full and 310-2B is empty. Node 310 input 2 is back-pressured due to full queue 310-2A. Even packets in queues 315-1A or 315-2A that are destined for node 300 output B are blocked, despite queue 340-2B being empty. This is true even if these packets are at the head of queues 315-1A or 315-2A, because link backpressure stalls the entire link. Because backpressure on switching node 300 Input 2 is caused only by the full queue 310-2A, the non-full queues also fed by Input 2, such as 310-2B are not a source of backpressure on Input 2. Elevating the arbitration priority afforded to 310-2B by arbiter 350B would not help to relieve backpressure on Input 2. Thus, a possible design optimization is to only consider fed-forward urgency from blocks 330 in cases of full queues 310, when aggregating urgency information to influence arbiters 350 and to send downstream via blocks 370.

A possible design choice is to try to avoid full queues by treating queue fullness as an urgency criterion in its own right. For example, a valid design choice might be to have aggregator 340-2A and thus arbiter 350-A treat full queues as a higher urgency than non-full ones. In the above example, 310-2A would receive more arbitration wins than 310-1A, until such time as 310-2A is no longer full. The duration of node 300 input 2 backpressure would be reduced, and thus the duration of victimized head-of-line blocking of packets in node 305 destined for node 300 output B.

Like other urgency criteria, this may be fed-forward to downstream switching nodes. Because the output link is back-pressured means that the next downstream switching node already “knows” that the relevant queue is full. Learning that additional switching node(s) further upstream also contains full queues might further influence arbitration priorities in favor of the full queue over other full competitor-queues that are also full, but are not similarly blocking full upstream queues.

An example of how meta-information about the presence of full queues may be aggregated in output aggregators like 370 or 375 is to consider the total number of full queues feeding a given link, or perhaps the greatest number of consecutive full queues in routes converging on the link.

It is noted that for any given queue participating in arbitration (e.g., for each queue converging on an output), the arbiter weighting is based on an aggregated age value, representing a plurality (e.g., all) packets in the queue, and not just the packet at the head of the queue. In a single, point-to-point first-in-first-out (FIFO) queue, the oldest packet is always at the head of the queue. But this is not always the case in a fabric having converging and diverging paths.

Various age-aggregation functions (e.g., sum and max) are possible. In an example, maximum-age (i.e. age of oldest packet) may be used if the objective is to first drain older packets from the fabric. The maximum age of all packets waiting in a queue may be determined using any of a variety of different methods. For example, the age may be determined by periodically “walking” the queues 210 and examining the ages of packets in the queues 210. Or for example, the age may be determined by maintaining a running histogram using up/down counters tracking the number of queue entries for each possible creation-time encoding.

The maximum age may be applied, directly or indirectly, as a weighting factor, in how the arbiter decides which competing queue receives the next opportunity for forward progress. As described above, arbitration weightings may be influenced by the maximum age of the packets already in the queues.

The packet ages are tracked across the entire multiple “hop” journey. The time stamps are not only stored with the packets in switch queues, but also carried with the packets across links. In effect, time stamps become an architected part of each packet's header. This poses a difficulty in that the system may not have a system-wide synchronized time reference to compare these time stamps to, as the packet passes between different chips. A time stamp attached to a packet at a source protocol agent needs to be meaningful at all points in the packet's journey (e.g., at each switch arbiter along the way).

In an example, a system-wide time reference may be implemented, or may include separate asynchronous time references implemented in each chip. The time reference may be a free-running counter running at a known tick rate. But it may be difficult to implement a system-wide time reference in a complex system with many nodes. A centralized time reference may create an undesirable single point of failure for the system. Distributed time synchronization may also be used, but can be complex in large fabrics.

The packet header's time stamp may also be modified at each link interface. That is, packets are stored in each queue with creation-time stamps defined relative to a local time reference. By storing time rather than age, a simple storage element may be used, rather than a free-running counter for every stored time stamp. When the packet is pulled from storage and sent over a link, the timestamps are converted to absolute age values for the journey across the link. Before being stored in the next queue, the time stamps are again converted to creation-time tags, but now relative to the time reference at this next node. Absolute age values are better than time stamps for packets in flight between chips, because they do not rely upon the chips having synchronized time references.

To convert a packet's time-stamp from creation time to absolute age, in preparation for transmission across a link, the absolute age is calculated by subtracting the creation-time value from the transmitting chip's current local time reference value. Suitable modulus arithmetic must be used.

To convert a packet's time-stamp from absolute age back to creation time, following receipt across a link, the creation time is calculated by subtracting the absolute age value from the transmitting chip's current local time reference value. Suitable modulus arithmetic must be used.

Because the local time references in the transmitting and receiving chips may not be synchronized between the two chips, the actual stored value representing creation in the receiving chip after the packet transits the link may differ from the previously-stored value in the transmitting chip before the same packet transited the link. But these two time stamps nonetheless represent the same creation time, with the differences in value accounting for differences between the two chip's unsynchronized time references.

The link transit time is generally insignificant when compared to the packet's queue storage times, and can be ignored. In other embodiments, travel time may be accounted for, e.g., based on known or estimated travel time between nodes.

Note that all local time references may run at the same tick rate, but still can be out of sync relative to one other (e.g., both in terms of current value and tick phase). In addition, tick rates are typically relatively slow to keep the stored timestamps and age-histogram counters small. Taken together, these factors imply a potential tick rounding error in packet age accuracy each time a packet crosses a link. If paths are supported with a large number of hops, this cumulative error could become significant. This is the limiting factor in choosing how coarse a tick duration to use.

The links communicate aggregated packet age information about upstream queues in the fabric. Thus, in addition to communicating the age of each packet as the packet crosses the link (e.g., as a field in the packet header), each link may also communicate the age of the oldest packet waiting to cross the link (if any). The age of the oldest packet may be included as a field in the link-idle packets to be communicated frequently and updated continually.

Similar to time stamps on individual packets, fed-forward aggregated information, in cases where it represents a time value, may be temporarily converted from time-stamp to age-stamp form while crossing each link, to allow individual switching nodes to be implemented with independent, rather than centralized or synchronized, time references.

Other examples are also contemplated. In systems having multiple independent flow-control domains sharing the same fabric (also referred to as message classes or virtual channels), it may be desirable to implement the feed-forward approach independently for each such domain. The underlying congestion and backpressure scenario may occur independently on each flow-control domain, and the arbiter weightings may be different on each. In addition, different flow-control domains may have different characteristics in terms of expected stall durations, maximum acceptable packet lifetimes, and different timeout hierarchies, to name a few examples.

In an example, different flow control domains may implement entirely independent feed-forward, aggregation, and arbitration bias logic, possibly including independent current-time reference counters, with different tick rates.

In another example, urgency for packets in different flow control domains may be allowed to influence arbitration between flow control domains competing for the opportunity to send packets across a link. Thus, a flow control domain containing more urgent priority packets may be given arbitration preference of a flow control domain containing less urgent packets.

The feed-forward information may implement varying degrees of specificity regarding which packets were used to produce the aggregated meta-information. For example, feed-forward information crossing a link may be used to convey the maximum age for all packets waiting to cross that link as a single number. Or for example, feed-forward information may convey a separate number representing the subset of packets bound for each possible next-hop path. Or for example, feed-forward information may convey a separate number representing the subset of packets bound for each possible eventual destination endpoint.

It is noted that providing more detailed information as the aggregated measure may incur a higher implementation cost, but may benefit overall fairness by being more selective in which arbiters are influenced by the urgency information. Generally, it is helpful if the granularity of urgency information detail matches the granularity of independent flow-control supported on the implemented link or queue structure. If switching nodes are implemented with conventional FIFO-based output-queued switches, link backpressure applies collectively to all waiting packets regardless of next-hop or final destination, and thus such fine granularity of urgency information serves no purpose.

By way of further explanation, if a crossbar has very fine-grained control of backpressure on the incoming links (e.g., next-hop route granularity: packets for a given output can be halted while those for a different output continue to flow), then fed-forward urgency information may be implemented using that same granularity (e.g., separate urgency numbers are fed forward corresponding to each next-hop link). In many implementations (such as in the output-queued switch examples shown in the drawings), crossbars are implemented with FIFO queues that co-mingle packets for all destinations. This allows packets for one destination to head-of-line block packets for another destination in the same queue. In this case, flow-control across the link is coarse granularity (all packets are stopped or started together without regard to route or destination), and so finer granularity of fed-forward urgency information does not need to be used.

A design choice is whether to allow feed-forward meta-information to propagate down entire paths, or just feed ahead across a single link. As described above, a packet considered urgent (e.g. because it is old) causes all arbiters along its entire multi-hop path to make arbitration choices that are favorable to that packet's delivery. This scheme works well in acyclic routing topologies, but does not work in topologies where the superposition of multiple paths combines to form cyclic paths, because aggregating urgency information around a cyclic path introduces positive feedback, perpetuating the apparent urgency even after the urgent packets have departed the fabric. As described here, the cyclic paths cause unacceptable circular aggregation paths in urgency information.

In a cyclic fabric, however, the feed-forward information may instead be propagated by a limited number (e.g., a single) hop. The feed-forward information received on a node input biases the arbitration at that node, without influencing the feed-forward information to other nodes further along the packet's path. The chosen feed-forward distance must be such that circular-dependencies in fed-forward urgency aggregation are impossible.

Before continuing, it should be noted that the examples described above are provided for purposes of illustration, and are not intended to be limiting. Other devices and/or device configurations may be utilized to carry out the operations described herein.

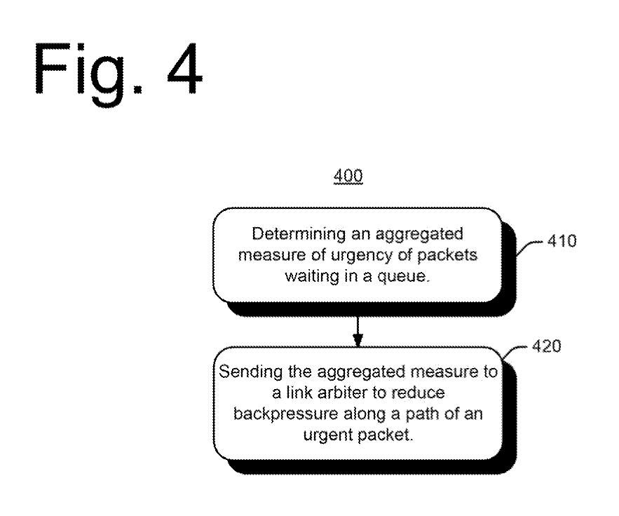

FIG. 4 is a flowchart illustrating example operations 400 which may be implemented for feed-forward arbitration. In an example, the components and connections depicted in the figures may be used. Operation 410 includes determining an aggregated measure of urgency of packets waiting to be sent through a link. The aggregated measure may be based, for example, on time data for a plurality of packets. Operation 420 includes sending the aggregated measure to an arbiter to reduce backpressure along a path of an urgent packet.

The operations shown and described herein are provided to illustrate example implementations. It is noted that the operations are not limited to the ordering shown. Still other operations may also be implemented.

Further operations may include sending the aggregated measure to a downstream link with one of the packets, between packet transmission, and/or independent of the packets.

The operations described herein may be used for managing traffic in the fabric. The operations described herein are used for minimizing the detrimental effect of back-pressure along a route of an urgent packet

It is noted that the examples shown and described are provided for purposes of illustration and are not intended to be limiting. Still other examples are also contemplated.

1. A method of feed-forward arbitration, comprising:
determining an aggregated measure of urgency of packets waiting in a queue; and
sending the aggregated measure to switching node arbiters along a path of an urgent packet, to reduce backpressure along the path of the urgent packet by biasing arbiters in favor of the urgent packet.

2. The method of claim 1, further comprising biasing arbitration of packets across multiple queues based at least in part on the aggregated measure, wherein the aggregated measure is associated with each competing queue.

3. The method of claim 2, wherein biasing arbitration prioritizes queues with more urgent packets over competing queues with less urgent packets.

4. The method of claim 3, wherein the queues win arbitration in decreasing order of urgency of packets in the queues.

5. The method of claim 4, wherein queues with more urgent packets win arbitration more often than queues with less urgent packets.

6. The method of claim 1, further comprising sending the aggregated measure to the link between packet transmissions.

7. The method of claim 1, further comprising arbitrating packets converging from multiple competing paths.

8. The method of claim 1, wherein the aggregated measure is based on time data for a plurality of packets.

9. The method of claim 1, further comprising prioritizing queues based upon urgent packets in the queues so that lower urgency packets drain from the path if the lower urgency packets obstruct the path of the urgent packet.

10. The method of claim 1, further comprising combining urgency information with the aggregated measure based only on contents of a queue, wherein the aggregated measure is determined based on a maximum age of all packets in the queue packets.

11. A feed-forward arbitration system comprising:
a plurality of queues; and
a switching node arbiter for the plurality of queues, the switching node arbiter managing the plurality of queues based on an aggregated measure of urgency of a queue.

12. The system of claim 11, wherein urgency is aggregated within each queue.

13. The system of claim 11, wherein arbitration is biased between competing queues.

14. The system of claim 13, wherein urgency is aggregated across multiple queues.

15. The system of claim 14, wherein urgency is sent across a link representing aggregated upstream queued packet urgency.

16. The system of claim 11, wherein urgency received across a link represents aggregated upstream queued packet urgency.

17. The system of claim 11, wherein received urgency is incorporated for upstream queues into urgency aggregation of a queue.

18. A system for feed-forward arbitration, comprising:
means for determining an aggregated measure of urgency of packets; and
means for biasing arbitration of packets based on the aggregated measure.

19. The system of claim 18, further comprising means for biasing a path of an urgent packet.

20. The system of claim 18, further comprising means for reducing back-pressure along a path of an urgent packet.
